(19) United States
(12) Patent Application Publication
(10) Pub. No.: US 2026/0252463 A1
(43) Pub. Date: Aug. 27, 2026

(54) APPLICATION BLUEPRINT ANALYSIS SYSTEM

(71) Applicant: Adobe Inc., San Jose, CA (US)

(72) Inventors: Daniel Richard Grossen, Lehi, UT (US); Prashanth Rudrabhat, San Jose, CA (US); Ivan A. Mironchuk, Tuckahoe, NY (US); Elliot Axel Puzenat, Le Plessis-Robinson (FR); Christopher David Hoffmann, Bluffdale, UT (US); Emilia Dobrin, San Jose, CA (US)

(73) Assignee: Adobe Inc., San Jose, CA (US)

(21) Appl. No.: 19/064,861

(22) Filed: Feb. 27, 2025

(51) Int. Cl. G06F 11/34; G06F 11/32

(52) U.S. Cl. CPC G06F 11/3438; G06F 11/324

(57) ABSTRACT

An application blueprint analysis system is described. In one or more examples, a communicative connection is established with a monitoring module configured to monitor user interaction with an application at a monitored computing device. The blueprint analysis system receives interaction data describing the monitored user interaction as a plurality of events. The events include captures of respective user interfaces involved in the monitored user interaction and navigational relationships of the user interfaces to each other. The blueprint analysis system forms an element visualization having an element hierarchy based on the navigational relationships and including the captures of the respective user interfaces. The blueprint analysis system then presents the element visualization for display in an analysis user interface.

### BACKGROUND

Applications are configurable to include hundreds and even thousands of user interfaces that are interconnected to support navigation to a variety of associated functionalities. Additionally, each of these user interfaces may include a variety of user interface elements such as buttons, text input options, navigational aids, pop-ups, and so on to implement these functionalities. Further the amount of functionality made available even via a single application continues to increase to increase richness and expand a user's experience.

Consequently, complexity introduces a variety of technical challenges in detecting and managing this multitude of user interfaces, techniques usable to navigate between the user interfaces, and user interface elements included in the user interfaces. This complexity, for instance, introduces a variety of challenges in order to gain a full understanding of application construction and supported navigation. Additionally, introduction of a new experience, messaging, and so forth based on a particular set of interactions is difficult without advanced technical knowledge. Conventional techniques to do so involve manual mapping which is prone to error and often fails to capture functionality of the application in its entirety. As a result, conventional techniques often fail to provide accurate insight into operation of the application, and therefore changes made based on these inaccuracies have a potential to introduce errors and reduce computational resource efficiency.

### SUMMARY

An blueprint analysis system is described that is configured to implement an element visualization (e.g., as a blueprint) that addresses technical challenges in evaluating complex applications with hundreds or thousands of interconnected user interfaces. A monitoring module, for instance, integrated into an application captures detailed metadata and screenshots of user interfaces in real-time, while an analysis module processes this data to reconstruct an element hierarchy and render an interactive blueprint of the entire application structure. The resulting element visualization supports a variety of technical functionalities not possible with conventional techniques, such as overlaying analytics data on the structural map, enabling precise positioning of in-app messages, and facilitating data-driven decisions for improvements. By providing a comprehensive view of the application's structure and user interactions, the blueprint analysis system allows developers, designers, and product managers to gain deep insights into computing device operation, user experiences, identify usability issues, and make targeted improvements, thereby enhancing computational resource efficiency and reducing potential errors in application development and optimization.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ application experience analysis techniques described herein.

FIG. 2A depicts a system in an example implementation showing operation of a monitoring module of FIG. 1 as generating interaction data based on an application, an analysis module of the blueprint analysis system, and an analysis user interface to display an element visualization.

FIG. 2B depicts a system in an example implementation showing operation of the blueprint analysis system in greater detail.

FIG. 3 depicts a system in an example implementation of initiation of a communication connection beginning with a connection phase to generate interaction data.

FIG. 4 depicts a system in an example implementation of a scan mode trigger to generate interaction data.

FIG. 5 depicts a system in an example implementation of event generation responsive to detecting user interface navigation.

FIG. 6 depicts an example implementation of a schema usable to implement a screen info event.

FIG. 7 depicts an example implementation of a schema usable to implement a request content operation.

FIG. 8 depicts an example implementation of an element visualization as generated using a system of FIG. 2 depicting a comprehensive visual representation of a structure and user flows of the application.

FIG. 9 depicts an example implementation of an element visualization as generated using the system of FIG. 2 depicting a trigger selection interface that enables configuration and management of different trigger events associated with elements on an application screen.

FIG. 10 depicts an example implementation of an element visualization as generated using the system of FIG. 2 as supporting application experience analysis.

FIG. 11 depicts an example implementation of an element visualization as generated using the system of FIG. 2 as a comprehensive visual representation of an application's structure and user interactions.

FIG. 12 depicts an example implementation of an element visualization as generated using the system of FIG. 2 as a hierarchical view of captures and navigation elements in the blueprint analysis system.

FIG. 13 depicts an example implementation of an element visualization as generated using the system of FIG. 2 as a timeline visualization showing a chronological sequence of events and corresponding metadata related to user interactions with the application.

FIG. 14 is a flow diagram depicting an algorithm as a step-by-step procedure in an example implementation of operations performable for accomplishing a result of interaction data generation and element visualization formation.

FIG. 15 is a flow diagram depicting an algorithm as a step-by-step procedure in an example implementation of operations performable for accomplishing a result of element visualization display and update in real time including suggestion generation using generative artificial intelligence.

FIG. 16 illustrates an example system including various components of an example device that can be implemented as any type of computing device as described and/or utilize with reference to FIGS. 1-15 to implement embodiments of the techniques described herein.

### DETAILED DESCRIPTION

### Overview

Application complexity continues to expand as functionalities are added to the hundreds and even thousands of user interfaces that are interconnected to support navigation through the application, typically through one-to-many relationships. Additionally, each of these user interfaces may include a variety of user interface elements that are configured to implement one or more operations thereby also increasing this complexity. Further, the amount of functionality made available even via a single application also continues to expand causing corresponding technical challenges in evaluating operation of the application, e.g., in real world scenarios.

The application, for instance, may include broken links, textual inaccuracies, user interface elements that users find difficult to interact with, navigation loops, and so on that are difficult to detect manually. Consequently, conventional techniques used to evaluate application operation that rely on manual mapping and error reporting typically identify errors “after the fact” and often fail to capture functionality of the application in its entirety. As a result, conventional techniques struggle to provide accurate insight into operation of the application, and therefore changes made based on these inaccuracies have a potential to introduce errors and reduce computational resource efficiency.

Accordingly, a blueprint analysis system is described that is configured to evaluate operation of an application, e.g., a mobile application, web application, locally-executed application, and so forth. To do so, the blueprint analysis system is configurable to form an element visualization (e.g., as a blueprint) that provides a comprehensive visual representation of an application's structure, user flows, in-app messaging, and so forth. As a result, the blueprint analysis system is configurable to address technical challenges of conventional techniques that are limited to viewing individual user interfaces (e.g., screens) in isolation, without indicating a full hierarchical relationship between the user interfaces or providing an integrated view of analytics and targeted experiences across the entire application.

In one or more examples, the blueprint analysis system is configurable to employ a multi-pronged approach. To do so, a monitoring module is integrated into an application. The monitoring module is configured to generate captures (e.g., “screenshots”) along with detailed metadata (e.g., coordinates of user interface elements, defined actions, events, etc.) about each user interface through monitoring user navigation through the application, e.g., as it occurs.

The analysis module is configured to process the events to reconstruct an element hierarchy describing hierarchical relationships between user interfaces and identify user interface elements, e.g., buttons, text entry portions, and so forth. The analysis module then renders an element visualization as an interactive blueprint of a structure of the application, e.g., in its entirety. The analysis module is also configurable to overlay analytics data of connections between nodes of the element visualization, e.g., using the captures of the user interfaces. The element visualization supports a variety of technical functionalities that are not possible in conventional techniques.

In a real-world example, an engineer for an application employs the blueprint analysis system to visually explore an application's structure through an element visualization presented in an analysis user interface, starting from a home screen and drilling down into product category and detail pages. The element visualization, through incorporated analytics data, may indicate that user engagement drops significantly on a particular product details screen. Using the blueprint view, the engineer may quickly identify existing in-application messages on that user interface and then use integrated tools of the analysis user interface to create a new targeted message encouraging users to engage with this item.

In this way, the blueprint analysis system allows for precise positioning of this message and to set triggering conditions based on observed behaviors without involving developers to refer to technical documentation about user interface names, user interface elements, and so forth which is difficult to perform manually in real-world scenarios. These techniques, for instance, are usable to bridge a gap in technical understanding of informal understanding of an application and architecture of the application and thereby improve efficiency in modifying functionality of the application. Further discussion of these and other examples is included in the following sections and shown in corresponding figures.

### Term Examples

A “software development kit” (SDK) is a collection of software tools, libraries, documentation, and code samples that developers use to create applications for specific platforms or frameworks. The SDK includes APIs (Application Programming Interfaces) that allow applications to interact with other software, development tools such as compilers, debuggers, and emulators, and monitoring functionality to track user interactions during the execution of an application. Additionally, SDKs provide documentation to guide developers and code samples to demonstrate how to implement various features, ensuring efficient software development and compatibility with the target platform.

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Application Experience Analysis Environment

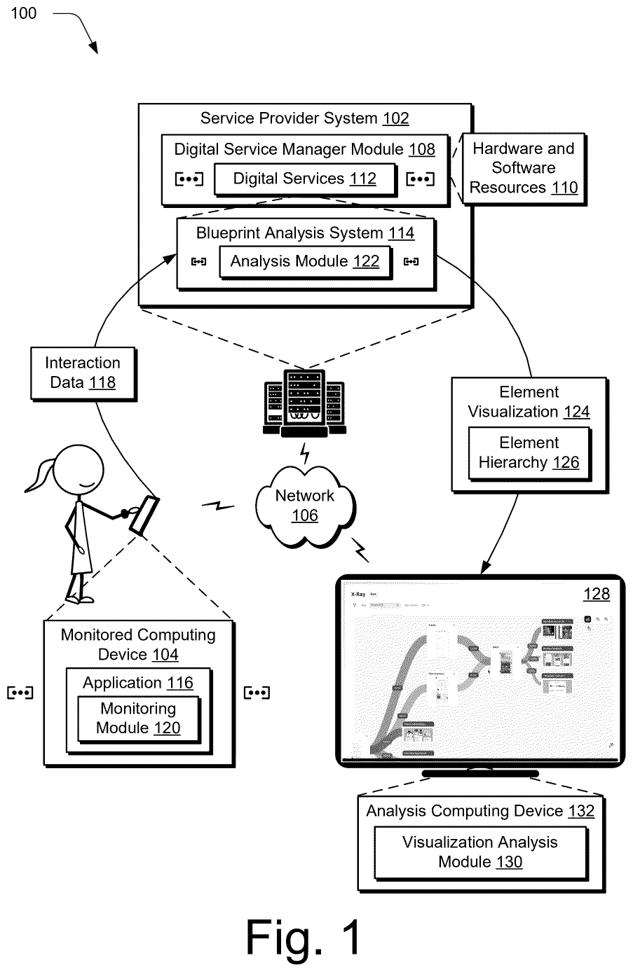

FIG. 1 is an illustration of a digital medium environment 100 in an example implementation that is operable to employ application experience analysis techniques described herein. The illustrated environment 100 includes a service provider system 102 and a monitored computing device 104 that are communicatively coupled, one to another, via a network 106. Computing devices are configurable in a variety of ways.

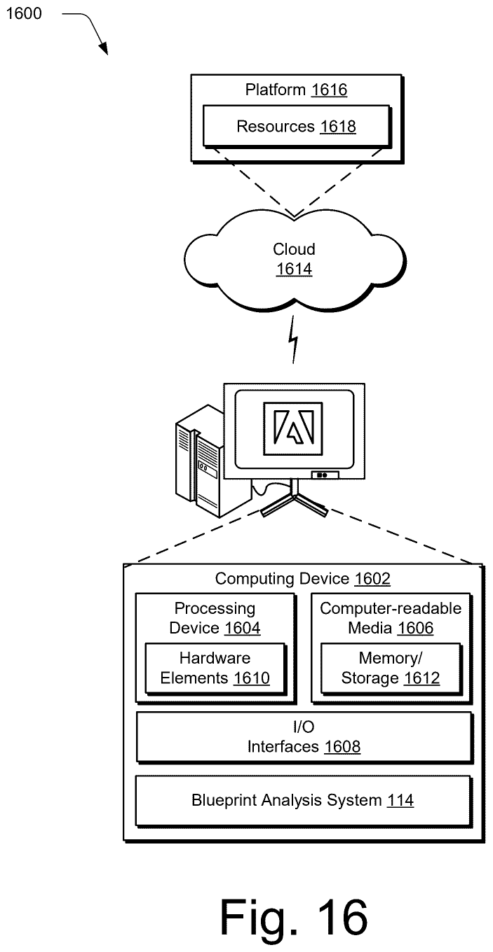

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 16.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., the monitored computing device.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on.

In the illustrated example, the digital services 112 are utilized to implement an blueprint analysis system 114. The blueprint analysis system 114 is configurable to analyze operation of an application 116 as executed by the monitored computing device 104, although local execution is also contemplated.

In order to analyze the operation, the blueprint analysis system 114 receives interaction data 118 from a monitoring module 120 executed along with the application 116. The interaction data 118, for instance, describes the interaction as events. The events are associated with corresponding user interfaces of the application 116 along with metadata describing navigational interaction between the user interfaces, characteristics of the user interfaces (e.g., user interface elements), and so forth. Generation of the events may be triggered in a variety of ways, examples of which include navigation to a user interface, interaction with an element included in the respective user interface, completing an action via the respective user interface, and so forth.

The interaction data 118 is communicated from the monitoring module 120 to an analysis module 122 of the blueprint analysis system 114. The blueprint analysis system 114 is configurable to generate an element visualization 124 detailing a structure and interrelationships of the user interfaces of the application 116 to each other. The element visualization 124, for instance, is configurable to include an element hierarchy 126 based on navigational relationships of the user interfaces and including captures (e.g., screenshots) of respective user interfaces.

The element visualization 124 is depicted as being displayed in an analysis user interface 128 on a display device by a visualization analysis module 130 of an analysis computing device 132. The element visualization 124 as illustrated in the analysis user interface 128 includes a plurality of nodes represented, respectively, by the plurality of captures and having a plurality of edges that interconnect the plurality of nodes to depict the element hierarchy 126 as based on the navigational relationships. The edges, for instance, may be configurable to indicate an amount of navigation, performance metrics (e.g., of surveys, in-app messaging), and so forth. The element visualization 124 is also configurable to include a variety of analytical data, examples of which include an indication of an amount of navigation performed between respective user interfaces, suggestions generated by generative artificial intelligence using machine learning based on the element visualization 124, and so forth. Although generation of the element visualization 124 is described as being performed by the blueprint analysis system 114 at the service provider system 102, the element visualization 124 may also be generated in a variety of other ways, such as at the monitored computing device 104 and/or the analysis computing device 132. Further discussion of these and other examples of application experience analysis is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Application Experience Analysis

The following discussion describes application experience analysis techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

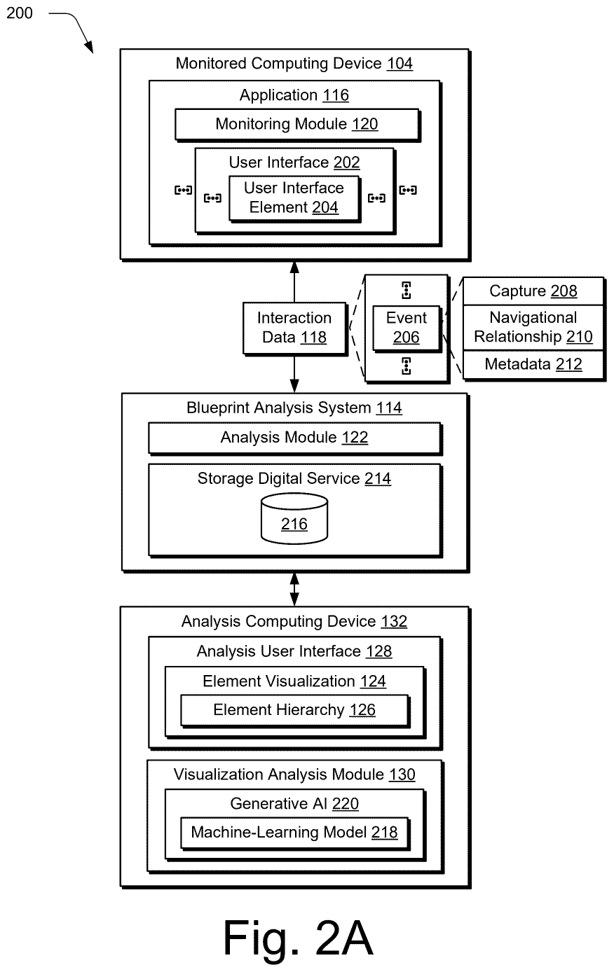

FIG. 2A depicts a system 200 in an example implementation showing operation of the monitoring module 120 as generating interaction data 118 based on the application 116, an analysis module 122 of the blueprint analysis system 114 as generating an element visualization 124, and an analysis user interface 128 to display the element visualization 124. To begin in this example, the monitoring module 120, as implemented by an application 116 on a monitored computing device 104, continuously tracks and records user interactions with user interfaces 202 and user interface elements 204, e.g., in real time as the interactions occur.

Based on the monitored user interaction, the monitoring module 120 generates interaction data 118 as a plurality of events 206. The events 206 include a capture 208 (e.g., screenshot) of a respective user interface 202, a navigational relationship 210, and metadata 212 associated with the user interfaces 202. The monitoring module 120, for instance, is configurable to capture a wide range of events, such as button clicks, text input, screen navigation, and gesture-based interactions. As user interaction is monitored involving engagement with various user interface elements 204 of the user interfaces 202, the monitoring module 120 generates detailed interaction data 118.

The interaction data 118 is configurable to include a variety of information, examples of which include timestamped events that describe each specific user action, including the type of interaction, the user interface elements 204 involved, and relevant contextual information as the metadata 212. The monitoring module 120 may also collect metadata 212 such as session duration, device type, and application version to provide a comprehensive view of the user experience. By systematically logging these events 206, the monitoring module 120 generates the interaction data 118 as a rich dataset that supports analysis to gain insights into computing device operation, user behavior, identify usability issues, and inform future improvements to a design and functionality of the application 116.

An engineer at a mobile game development company, for instance, may notice that players are abandoning a newly released application 116 as a puzzle game at an unusually high rate after a first few levels. Concerned about user retention and overall game performance, the engineer decides to implement a monitoring module 120 to gain deeper insights into how players are interacting with the application 116.

After integrating the monitoring module 120 into the application 116 (e.g., using a respective software development kit (SDK)), the engineer deploys an update to users'devices. As players interact with the application 116, the monitoring module 120 (e.g., when in “scan mode”) continuously tracks and records interactions with the user interfaces 202 and user interface elements 204 in real-time. The monitoring module 120 captures events 206 such as button presses, level selections, in-game purchases, and navigation between different user interface 202. For each significant interaction, the monitoring module 120 generates a capture 208 of a current game state, records a navigational relationship 210 between different game user interfaces, and collects metadata 212 including session duration, device type, and game version. At each event, for instance, the monitoring module 120 and/or the analysis module determines relationships based on a sequence of events received and at each event, may “look ahead” to determine whether the user interface is a child or parent UI.

In another example, the blueprint analysis system 114 is also configured to compare applications, different versions of a same application, and so forth. The blueprint analysis system 114, for instance, may depict differences in captures 208, navigational relationships 210, metadata 212 and so on visually in a user interface. The blueprint analysis system 114 is then configuration to generate analytics showing trends and comparisons between the two, e.g., as “hints” for further modifications.

This comprehensive interaction data 118 supports analysis of player behavior patterns, supports an ability to identify potential usability issues, and supports a technique to gain insights into how users experience the game as further described below.

The analysis module 122 of the blueprint analysis system 114 receives the interaction data 118 as an input. A storage digital service 214 is configurable to store the events 206 of the interaction data 118 in a storage device 216, e.g., for later retrieval via respective storage identifiers (IDs) as further described below. The storage digital service 214, for instance, may include storage identifiers as tying events with corresponding captures, e.g., that are received at a later point in time.

The analysis module 122 is also configurable to generate the element visualization 124 based on the interaction data 118. The analysis module 122, for instance, processes the interaction data 118 collected by the monitoring module 120 to generate a comprehensive element visualization 124 of the application 116. The analysis module 122 begins by parsing the events 206, including the captures 208, navigational relationships 210, and associated metadata 212. The analysis module 122 then reconstructs the hierarchical structure of the application's user interfaces as an element hierarchy 126, mapping out how different user interfaces 202 connect and relate to each other.

As part of this, the analysis module 122 is configurable to identify and catalog individual user interface elements 204 across each of the captures 208 of respective user interfaces 202, noting corresponding properties, positions, and interactive capabilities. The analysis module 122 then overlays the user interaction data onto a structural map depicting the navigational relationship 210, creating visual representations of user flows, engagement patterns, and potential points of operational concern.

In this way, the element visualization 124 is configured as an interactive, visual blueprint of an entirety of the application 116 that displays a structure of the application 116 as well as how users navigate and interact with the structure. The element visualization 124, for instance, is usable to highlight frequently used paths, show where users tend to drop off, and identify user interface elements 204 that receive the most or least interaction. This comprehensive visual representation as implemented by the element visualization 124 allows developers, designers, and product managers to gain deep insights into how users actually experience and interact with the application, facilitating data-driven decisions for improvements and optimizations which is not possible in conventional techniques.

Continuing with the previous example, by examining the rich dataset of the interaction data 118, an engineer may discover that many players struggle with a particular puzzle mechanic at a third level of the application 116, leading to frustration and game abandonment. Armed with this knowledge, the engineer can then focus on improving that specific game element to enhance player retention and overall game enjoyment, which is difficult if not impossible to perform in real-world scenarios involving complex application structures using conventional techniques.

The visualization analysis module 130 is configurable, alone or in combination with the analysis module 122 to leverage the element visualization 124 to support a variety of usage scenarios. The visualization analysis module 130, for instance, is configured to leverage one or more machine-learning models 218 as part of generative AI 220 to process the element visualization 124 to gain a variety of insights.

A product manager for a fitness tracking application, for instance, may leverage the element visualization 124 in conjunction with a machine learning model 218 to generate AI-powered suggestions for improvements to operation of the application 116. The suggestions, for instance, are configurable to suggestion is configured to improve an amount of navigation to a respective the user interface, add a user interface, or remove a respective user interface. The one or more machine-learning models 218, trained on historical user interaction data and successful application designs, for instance, analyzes the element visualization 124 to identify patterns and potential areas for enhancement. For instance, it might notice that users frequently abandon the workout logging process on a particular screen. Based on this insight, the generative AI 220 generates suggestions such as simplifying the UI layout, adding auto-complete functionality for exercise names, or implementing a quick-log feature for common workouts. The generative AI 220, through use of the one or more machine-learning models 218, may also propose personalized navigation flows for different user segments, suggesting the addition of shortcuts or reorganizing menu items to optimize the user experience for both novice and experienced users.

In another example, an engineer associated with an application employs the element visualization 124 and generative AI 220 to optimize a conversion funnel. To do so, the machine learning model 218 analyzes user interaction patterns across an entirety or part of an application journey from product browsing to checkout, analyzing performance across versions of applications, and so forth. From this, the machine-learning model 218 identifies that users often hesitate on the shipping options page before abandoning their carts. The generative AI 220 then generates suggestions for streamlining this process, such as implementing a one-click express shipping option, displaying estimated delivery dates more prominently, or offering a loyalty program with free shipping.

Additionally, the one or more machine-learning models 218 may suggest dynamic adjustments to a respective user interface 202 based on user behavior, such as highlighting sale items for price-sensitive users or showcasing premium products for users with a history of high-value purchases. These suggestions as generated by the generative AI 220 and grounded in the comprehensive interaction data 118 provided by the element visualization 124 support data-driven decisions that directly address user pain points and preferences and support insights that are not possible using conventional techniques.

FIG. 2B depicts a system 250 in an example implementation showing operation of the blueprint analysis system in greater detail. The blueprint analysis system 114 is communicatively coupled to the monitored computing device 104 and third-party digital services 252 in the illustrated example. The blueprint analysis system includes one or more experience controllers (UI) 252 that are communicatively coupled with experience services 256. Examples of experience services 256 include a storage service 258 (e.g., blob service), a WebSocket service 260, and an API service 262.

In an implementation, both the experience controllers (UI) 254 and monitored computing device 104 communicate with the blueprint analysis system 114 via a real-time, full-duplex WebSocket. Additionally, the experience controllers (UI) 254 are configurable to send commands to take actions (e.g.., “take an initial screenshot”) within the device context. The experience controllers (UI) 254 are configurable to load historical events (e.g., screenshots, metadata, and so on as further described below) along with analytics and campaign/experience data, e.g., via a “REST API.”

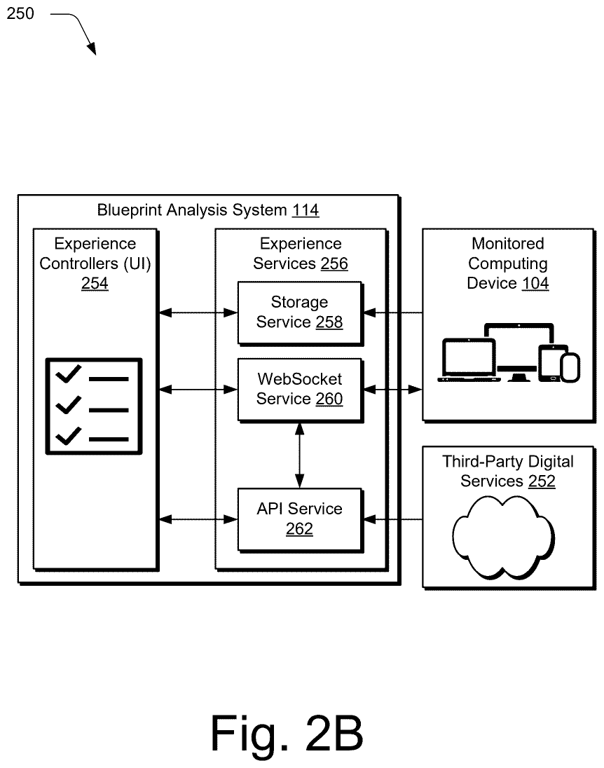

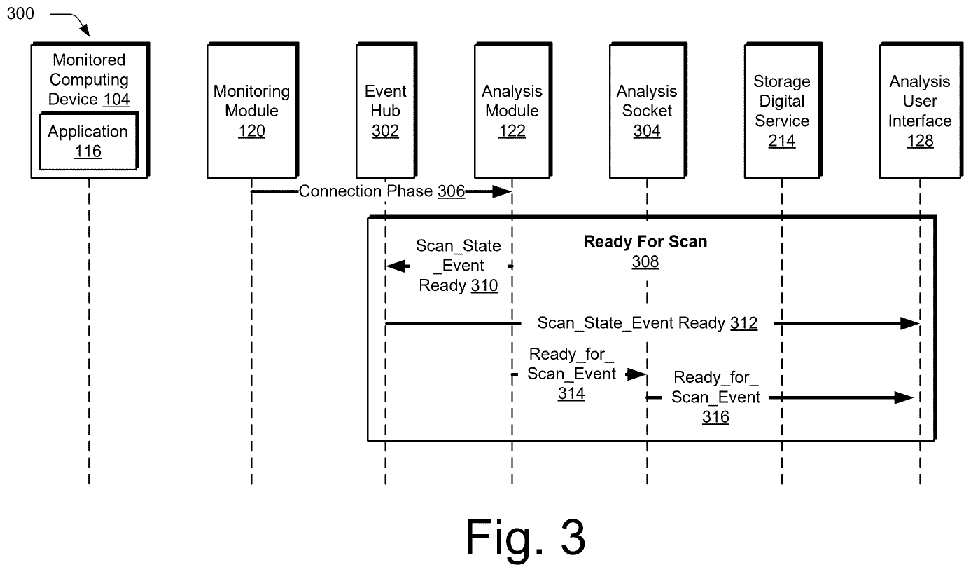

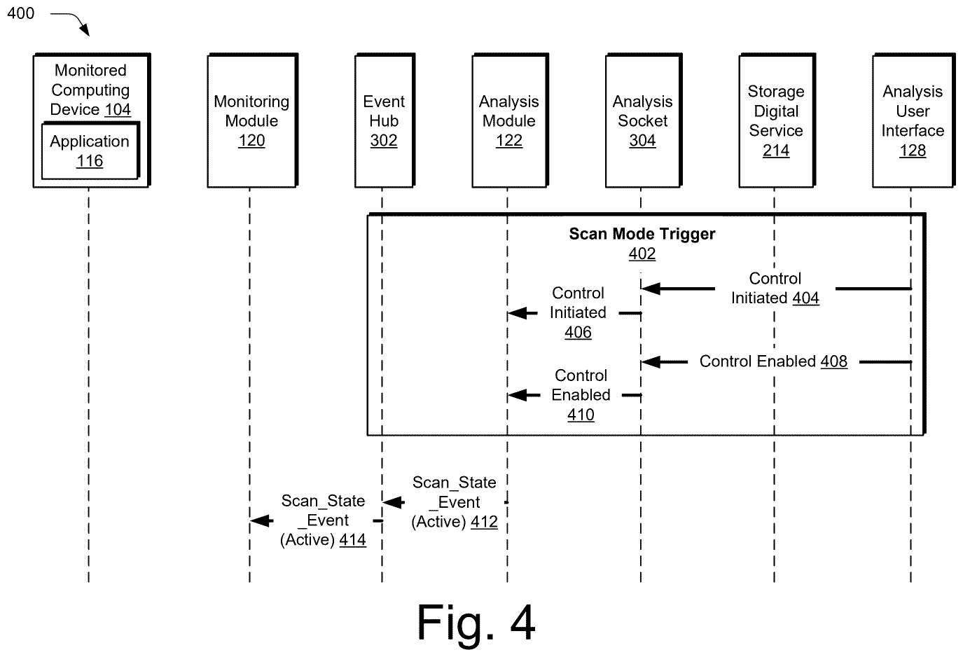

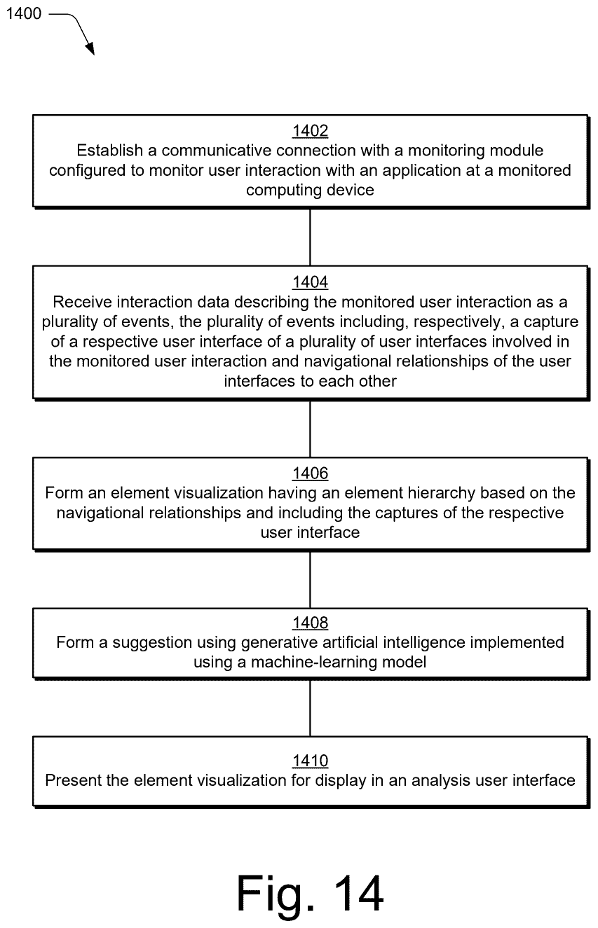

FIG. 3 depicts a system 300 in an example implementation of initiation of a communication connection beginning with a connection phase to generate interaction data 118. FIG. 4 depicts a system 400 in an example implementation of a scan mode trigger to generate interaction data 118. FIG. 5 depicts a system 500 in an example implementation of event generation responsive to detecting user interface navigation. FIG. 14 is a flow diagram depicting an algorithm 1400 as a step-by-step procedure in an example implementation of operations performable for accomplishing a result of interaction data generation and element visualization formation. In the following discussion, reference is made in parallel to FIGS. 3, 4, 5, and 14.

To begin at FIG. 3, a communicative connection is established with a monitoring module configured to monitor user interaction with an application at a monitored computing device (block 1402). The system 300 represents the monitored computing device 104 as having the application 116, the monitoring module 120, an event hub 302 configured to queue events 206, the analysis module 122, an analysis socket 304 of the service provider system 102, the storage digital service 214, and the analysis user interface 128.

The process begins with a connection phase 306 that establishes communication links between the monitored computing device 104, monitoring module 120, event hub 302, analysis socket 304, and analysis module 122. To establish the connections, a “ready for scan” 308 signal is initiated, indicating the system is prepared to begin scanning and collecting data. The ready for scan signal 308 initiates the monitoring module 120 on the monitored computing device 104 to capture user interactions and generate events as the interaction data 118. To do so in a first example, the system 300 generates various scan state events, including scan state event 310 and a scan state event ready 312. In a second example, the system 300 generates a ready for scan event 314, and scan event ready 316. These scan state events may be sent back through the analysis socket 304 and event hub 302 to update the monitoring module 120 on the current scan status. This operation flow initiates continuous monitoring and data collection of application experiences, providing insights into user behavior and application performance.

At FIG. 4, a scan mode trigger 402 is implemented to initiate operation of a scan mode to generate the interaction data 118. The process begins with activation of a scan mode trigger 402, which generates a scan state event 404 in a first example. This scan state event 404 is received by the event hub 302, signaling the start of the scanning process. The event hub 302 communicates with the analysis module 122 through the analysis socket 304, preparing the analysis module 122 for incoming data. As part of the scan mode initiation, control mechanisms are activated, including control initiated 406 in the first example.

In a second example, control enabled event 408 and a control enabled event 410 are generated, which is processed by the analysis module 122. The analysis module 122 then prepares to receive and process interaction data 118 from the monitored application. The analysis module 122 also communicates with the storage digital service 214 to ensure data storage capabilities are ready. The analysis module 122 communicates a scan state event (active) 412 to the event hub 302, which is then communicated as scan state event (active) 414 to the monitoring module 120. Once each of the components are prepared, the system 400 begins collecting and processing interaction data 118 as further described below.

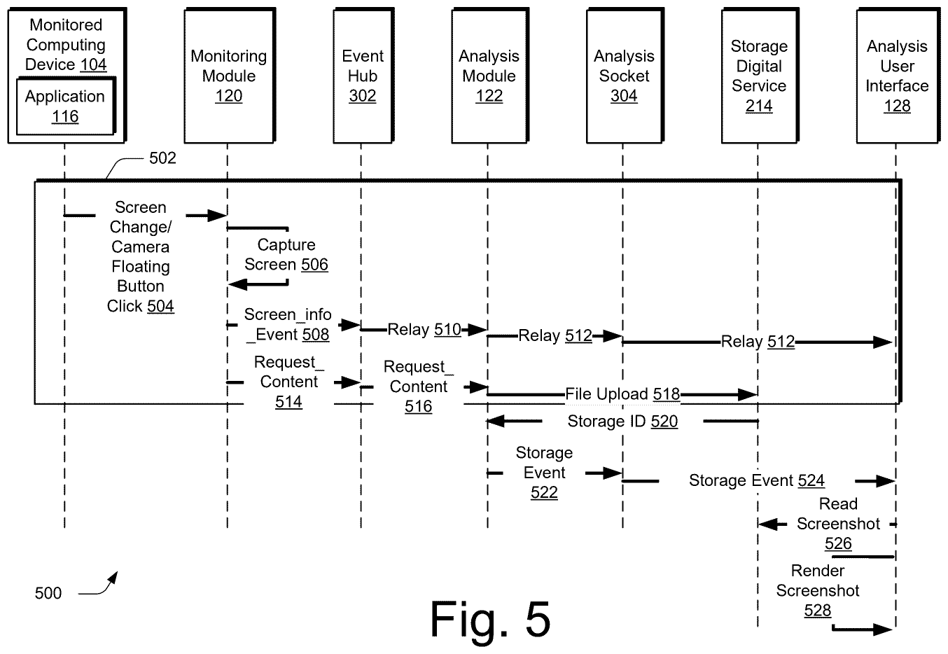

At FIG. 5, interaction data 118 is generated using the initiated components of FIGS. 3 and 4 in response to a screen change 502. The process begins with the analysis socket 504 establishing communication for data flow. The monitored computing device 104 initiates a capture screen 506 operation, which leads to the generation of a screen info event 508. This screen info event 508 contains detailed information about the captured screen. FIG. 6 depicts an example implementation of a schema 600 usable to implement a screen info event.

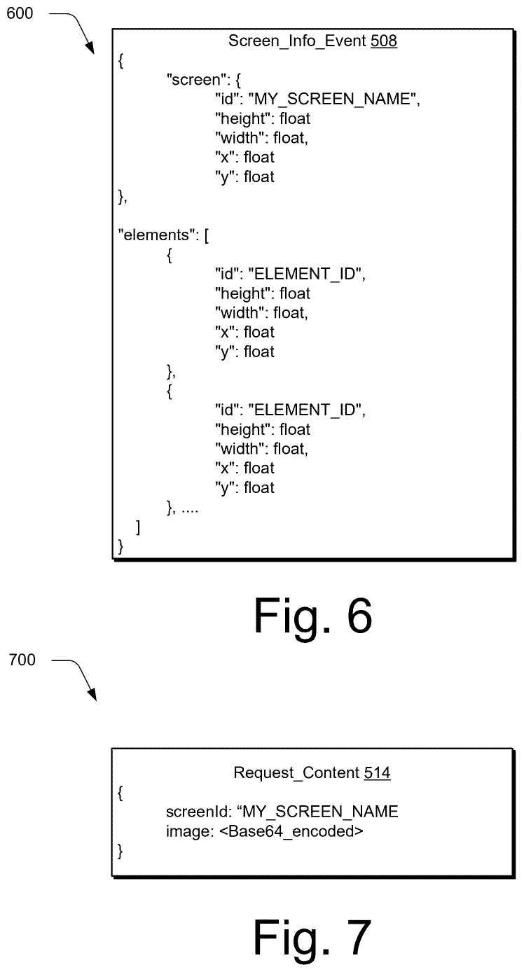

Following the screen info event 508, the system 500 performs a request content 514 operation, which is relayed 510 to the analysis module 122 and then relayed 512 to the analysis socket 304. The relays are followed by another request content 516 operation. FIG. 7 depicts an example implementation of a schema 700 usable to implement a request content operation. These content request operations gather additional data related to the captured screen. The system 500 then proceeds with a file upload 518 operation, which results in the generation of a storage identifier 520. This storage identifier 520 is used to track the uploaded file in the system. The storage identifier 520 triggers a storage event 522, followed by another storage event 524, ensuring the captured data is properly stored and indexed. After the storage events, the system 500 performs a read screenshot 526 operation to retrieve the stored screen capture. Finally, the process concludes with a render screenshot 528 operation, where the captured and processed screen information is prepared for display. This sequence of operations enables the system to capture, process, store, and prepare interaction data 118 for analysis and visualization.

Returning again to FIG. 2, interaction data is received that describes the monitored user interaction as a plurality of events. The plurality of events include, respectively, a capture of a respective user interface of a plurality of user interfaces involved in the monitored user interaction and navigational relationship of the user interfaces to each other (block 1404). An element visualization is formed having an element hierarchy based on the navigational relationship and including the captures of the respective user interface (block 1406). The element visualization 124, in one or more examples, includes a suggestion formed using generative artificial intelligence implemented using a machine-learning model (block 1408) as previously described. The element visualization 124 is then presented for display in an analysis user interface (block 1410). The element visualization 124 is configurable in a variety of ways.

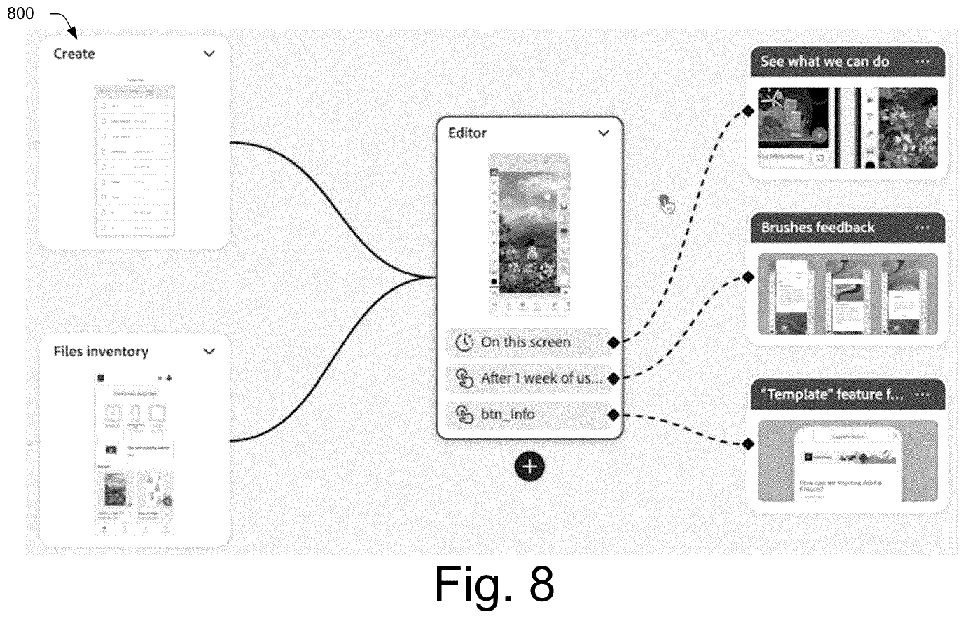

FIG. 8 depicts an example implementation 800 of an element visualization 124 as generated using the system 200 of FIG. 2 depicting a comprehensive visual representation of a structure and user flows of the application 116. The element visualization 124 displayed in the analysis user interface 128 of FIG. 8 depicts a comprehensive visual representation of an application's structure and user flows. The element visualization 124 includes a plurality of nodes represented by captures of respective user interfaces, interconnected by a plurality of edges that depict the element hierarchy 126 based on navigational relationships between the user interfaces.

At a top level, the element visualization 124 shows a create screen, which branches downward to connect with other interface elements. The element visualization 124 presents multiple interface elements arranged in a tree-like structure, with dashed lines indicating relationships between different components. In the center of the element visualization 124, an editor section connects to various interface elements through branching paths, illustrating how users can navigate through different sections of the application 116. The element visualization 124 provides a blueprint view of the application's entire structure, allowing developers, designers, and product managers to visually explore the application's layout, starting from top-level screens and drilling down into detailed pages and components. This comprehensive visual representation enables deep insights into how users experience and interact with the application 116, facilitating data-driven decisions for improvements and optimizations.

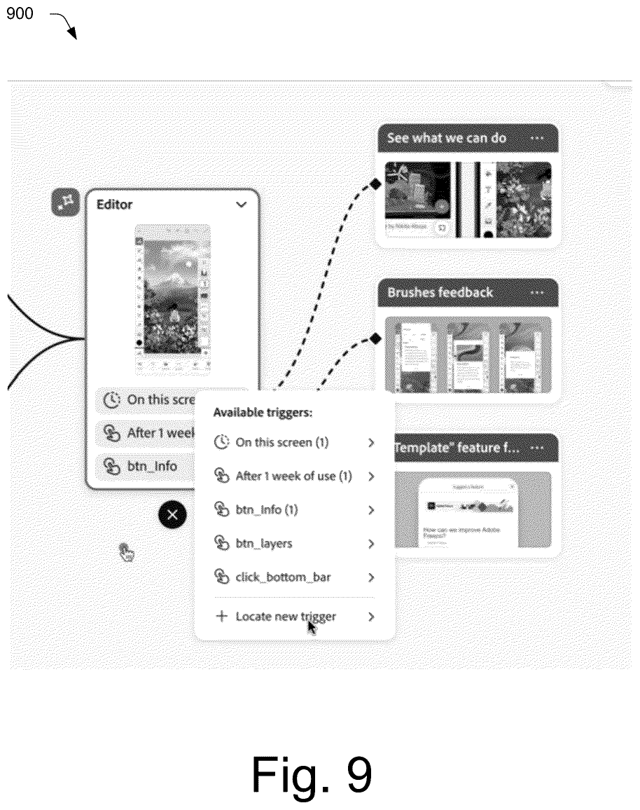

FIG. 9 depicts an example implementation 900 of an element visualization 124 as generated using the system 200 of FIG. 2 depicting a trigger selection interface that enables configuration and management of different trigger events associated with elements on an application screen. The element visualization 124 includes an editor view containing a preview of a user interface 202 with various user interface elements 204.

The element visualization 124 incorporates a dropdown menu showing available triggers that can be configured for the user interface 202. The available triggers section lists several options including “On this screen,” “After 1 week of use,” “btn_Info,” “btn_layers,” and “click_bottom_bar,” with a “Locate new trigger” option appearing at the bottom of the trigger list. The element visualization 124 also displays preview cards on the right side showing different aspects of the application experience, such as “See what we can do,” “Brushes feedback,” and a “Template feature.” This comprehensive visual representation allows developers and analysts to explore the application's structure and configure specific triggers based on user interactions, supporting data-driven decisions for improving user engagement and application functionality. The element visualization 124 in this view enables precise positioning of in-application messages and setting of triggering conditions based on observed behaviors, facilitating targeted improvements to the application's user experience.

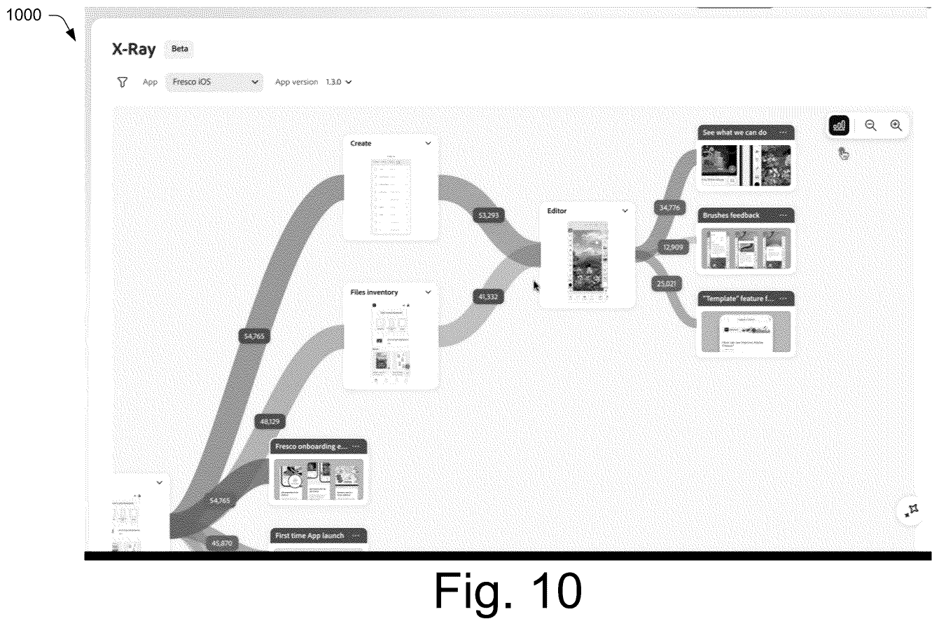

FIG. 10 depicts an example implementation 1000 of an element visualization 124 as generated using the system 200 of FIG. 2 as supporting application experience analysis. The element visualization 124 depicts a sequence of analyzed stages for capturing and processing screen information and user interactions within an application. The element visualization 124 begins with receiving screen information from a monitored computing device 104 executing the application 116. The screen information flows to a step where the information is processed by the analysis module 122.

From this point, the element visualization 124 branches into three parallel paths, representing different types of information processing. One path leads to a step showing real-time preview information, another path flows to a step showing forms information, and the third path proceeds to a step showing game information. The element visualization 124 then shows these three paths converging to a subsequent step where additional screen information is processed. The element visualization 124 continues with another branching into three paths, each showing different types of screen elements and interactions that can be captured and analyzed. This comprehensive visual representation allows developers and analysts to understand the flow of information and processing steps involved in analyzing application experiences, including how screen information is captured, processed, and organized into different categories for analysis. The element visualization 124 in this view enables a detailed understanding of the application's structure and user interactions, facilitating data-driven decisions for improving the application's functionality and user experience.

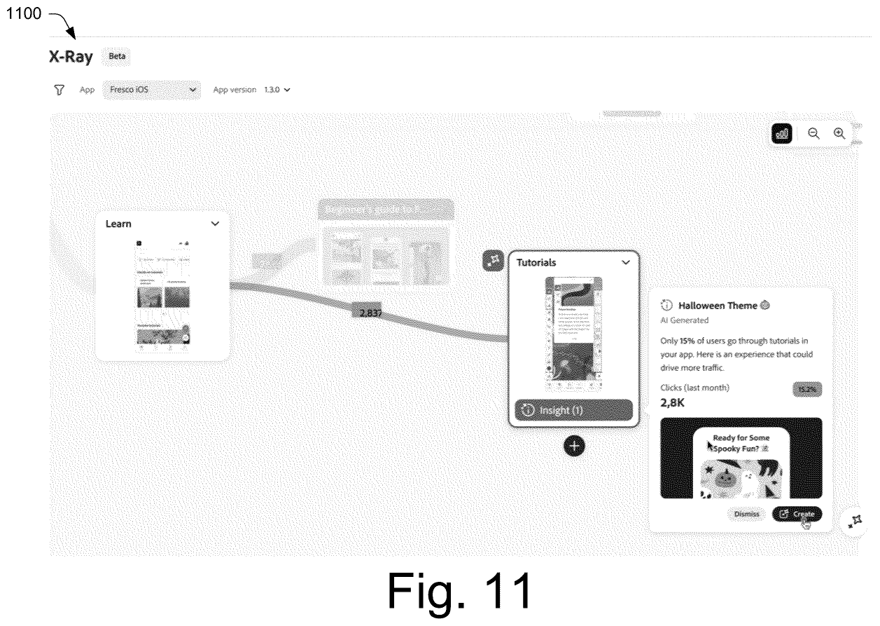

FIG. 11 depicts an example implementation 1100 of an element visualization 124 as generated using the system 200 of FIG. 2 as a comprehensive visual representation of an application's structure and user interactions. The element visualization 124 includes a hierarchical display showing connected screens or views from the application 116, represented as a plurality of nodes interconnected by edges depicting the element hierarchy 126 based on navigational relationships between the user interfaces 202.

The element visualization 124 incorporates interaction data, e.g., “2.8K,” which represents data collected regarding user interactions with the application 116. This interaction data is integrated into the element visualization 124, allowing analysts and developers to visualize relationships between different application screens and associated interaction metrics. The element visualization 124 in this view enables exploration of the application's structure, starting from top-level screens and drilling down into detailed pages and components.

By displaying the interaction data within the context of the application's structure, the element visualization 124 facilitates deep insights into how users navigate and interact with the application 116. This comprehensive visual representation supports data-driven decision-making for improvements and optimizations to the application's user experience and functionality. In this way, the element visualization 124 supports precise analysis of user engagement patterns and potential areas for enhancement within the application 116.

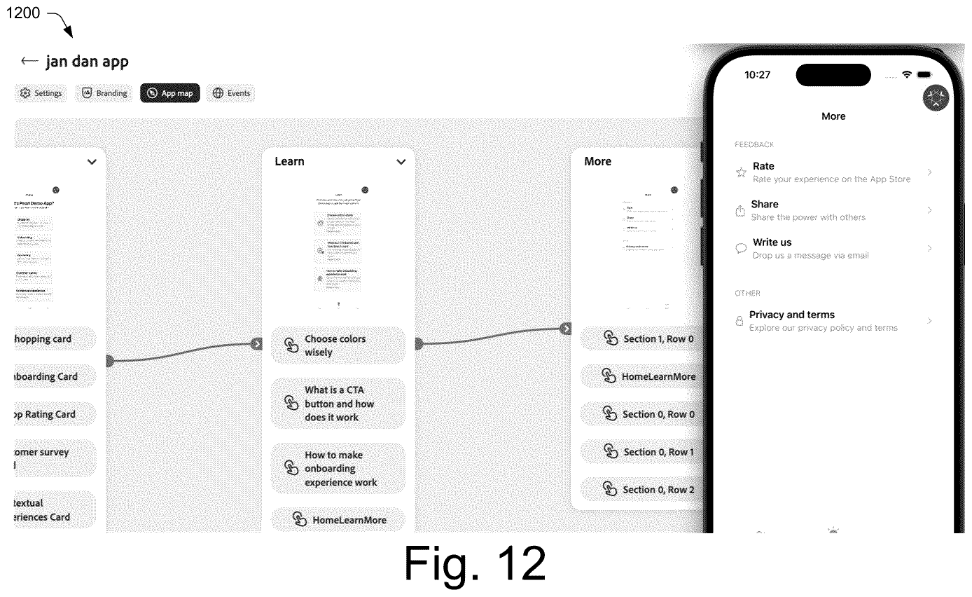

FIG. 12 depicts an example implementation 1200 of an element visualization 124 as generated using the system 200 of FIG. 2 as a hierarchical view of captures and navigation elements in the blueprint analysis system 114. The element visualization 124 depicts a “jan dan” application, showing multiple levels of interconnected user interfaces 202 and user interface elements 204. The element visualization 124 arranges the user interfaces 202 vertically as nodes with connecting edges showing the navigational relationships between different user interface elements 204 and user interfaces 202.

The element visualization 124 includes various user interface elements 204 represented as nodes connected by edges, indicating the hierarchical flow and relationships between user interfaces 202. These nodes contain text labels identifying different user interfaces 202 and user interface elements 204 within the application 116. The element visualization 124 provides a comprehensive visual representation of how users can navigate through different sections and elements of the application interface. This blueprint view of the application's structure allows developers, designers, and product managers to visually explore the application's layout, starting from top-level screens and drilling down into detailed pages and components. The element visualization 124 in this view enables deep insights into the application's navigation structure, facilitating data-driven decisions for improvements and optimizations to enhance user experience and application functionality.

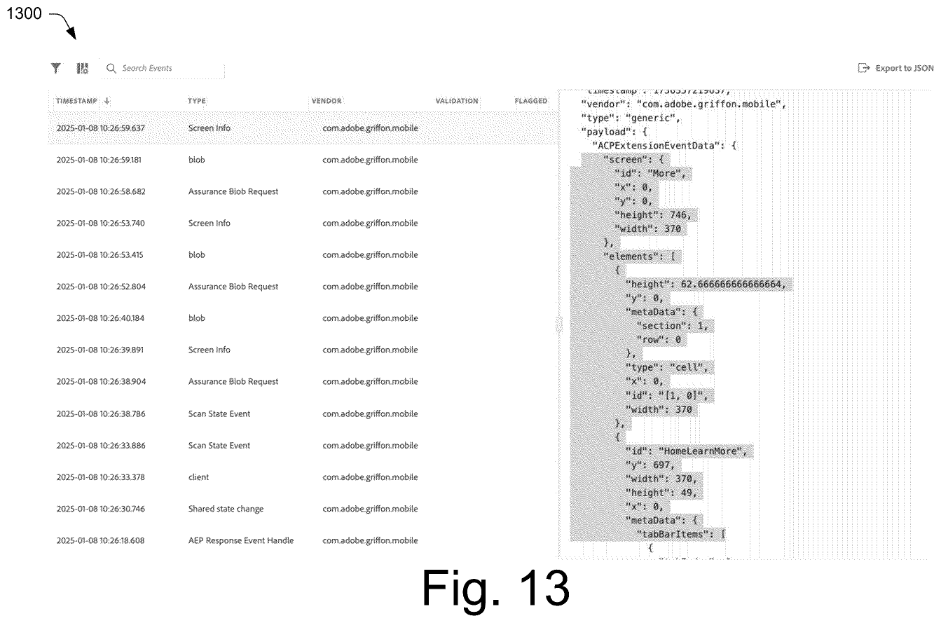

FIG. 13 depicts an example implementation 1300 of an element visualization 124 as generated using the system 200 of FIG. 2 as a timeline visualization showing a chronological sequence of events and corresponding metadata related to user interactions with the application 116. The element visualization 124 displays multiple entries arranged vertically, with each entry containing information about events 206, actions, and data types associated with different timestamps.

This timeline representation allows developers and analysts to visualize the sequence of user interactions and system events over time. The element visualization 124 includes detailed metadata 212 for each event 206, providing insights into the specific actions taken by users, the user interfaces 202 involved, and associated data generated during the interaction.

By presenting this information in a chronological format, the element visualization 124 enables analysis of user behavior patterns, identification of potential usability issues, and tracking of user journeys through the application 116. The timeline visualization of the element visualization 124 supports data-driven decision-making by allowing developers and product managers to identify trends, pinpoint areas of high or low engagement, and understand the temporal aspects of user interactions with the application 116. This comprehensive view of user activity over time facilitates targeted improvements to the application's functionality and user experience based on observed patterns of interaction.

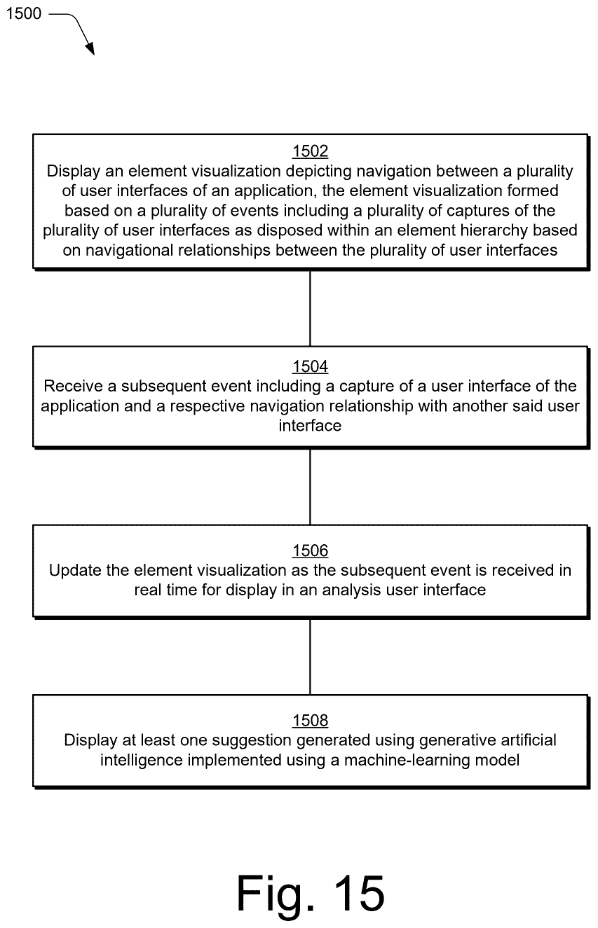

FIG. 15 is a flow diagram depicting an algorithm 1500 as a step-by-step procedure in an example implementation of operations performable for accomplishing a result of element visualization display and update in real time including suggestion generation using generative artificial intelligence. This algorithm begins with displaying an element visualization depicting navigation between a plurality of user interfaces of an application (block 1502). The element visualization is formed based on a plurality of events including a plurality of captures of the plurality of user interfaces as disposed within an element hierarchy based on navigational relationships between the plurality of user interfaces.

A subsequent event is received including a capture of a user interface of the application and a respective navigation relationship with another said user interface (block 1504). To do so, the monitoring module 120 captures a new user interaction with the application 116, such as a user navigating to a previously unvisited screen or interacting with a new user interface element 204.

In response the element visualization is updated as the subsequent event is received in real time for display in an analysis user interface (block 1506). The analysis module 122, for instance, may process the new event data and dynamically update the element visualization 124 to reflect the new interaction, such as adding a new node to represent the newly visited screen or updating edge weights to reflect increased navigation along a particular path.

At least one suggestion is also displayed that is generated using generative artificial intelligence implemented using a machine-learning model (block 1508). To do so, the visualization analysis module 130 employs the machine-learning model 218 to analyze the updated element visualization 124 and generate suggestions for improving the application's user experience. For example, the generative AI 220 might suggest adding a shortcut to a frequently accessed screen or simplifying a navigation path. A variety of other examples are also contemplated.

### Example System and Device

FIG. 16 illustrates an example system generally at 1600 that includes an example computing device 1602 that is representative of one or more computing systems and/or devices that implement the various techniques described herein. This is illustrated through inclusion of the blueprint analysis system 114. The computing device 1602 is configurable, for example, as a server of a service provider, a device associated with a client (e.g., a client device), an on-chip system, and/or any other suitable computing device or computing system.

The example computing device 1602 as illustrated includes a processing device 1604, one or more computer-readable media 1606, and one or more I/O interface 1608 that are communicatively coupled, one to another. Although not shown, the computing device 1602 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1604 is representative of functionality to perform one or more operations using hardware. Accordingly, the processing device 1604 is illustrated as including hardware element 1610 that is configurable as processors, functional blocks, and so forth. This includes implementation in hardware as an application specific integrated circuit or other logic device formed using one or more semiconductors. The hardware elements 1610 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1606 is illustrated as including memory/storage 1612 that stores instructions that are executable to cause the processing device 1604 to perform operations. The computer-readable storage medium is configured for storing instructions that, responsive to execution by the processing device, causes the processing device to perform operations. The memory/storage 1612 represents memory/storage capacity associated with one or more computer-readable media. The memory/storage 1612 includes volatile media (such as random access memory (RAM)) and/or nonvolatile media (such as read only memory (ROM), Flash memory, optical disks, magnetic disks, and so forth). The memory/storage 1612 includes fixed media (e.g., RAM, ROM, a fixed hard drive, and so on) as well as removable media (e.g., Flash memory, a removable hard drive, an optical disc, and so forth). The computer-readable media 1606 is configurable in a variety of other ways as further described below.

Input/output interface(s) 1608 are representative of functionality to allow a user to enter commands and information to computing device 1602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1602 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1602. By way of example, and not limitation, computer-readable media includes “computer-readable storage media” and “computer-readable signal media.” “Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer. “Computer-readable signal media” refers to a signal-bearing medium that is configured to transmit instructions to the hardware of the computing device 1602, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1610 and computer-readable media 1606 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1610. The computing device 1602 is configured to implement particular instructions and/or functions corresponding to the software and/or hardware modules. Accordingly, implementation of a module that is executable by the computing device 1602 as software is achieved at least partially in hardware, e.g., through use of computer-readable storage media and/or hardware elements 1610 of the processing device 1604. The instructions and/or functions are executable/operable by one or more articles of manufacture (for example, one or more computing devices 1602 and/or processing devices 1604) to implement techniques, modules, and examples described herein.

The techniques described herein are supported by various configurations of the computing device 1602 and are not limited to the specific examples of the techniques described herein. This functionality is also implementable all or in part through use of a distributed system, such as over a “cloud” 1614 via a platform 1616 as described below.

The cloud 1614 includes and/or is representative of a platform 1616 for resources 1618. The platform 1616 abstracts underlying functionality of hardware (e.g., servers) and software resources of the cloud 1614. The resources 1618 include applications and/or data that can be utilized while computer processing is executed on servers that are remote from the computing device 1602. Resources 1618 can also include services provided over the Internet and/or through a subscriber network, such as a cellular or Wi-Fi network.

The platform 1616 abstracts resources and functions to connect the computing device 1602 with other computing devices. The platform 1616 also serves to abstract scaling of resources to provide a corresponding level of scale to encountered demand for the resources 1618 that are implemented via the platform 1616. Accordingly, in an interconnected device embodiment, implementation of functionality described herein is distributable throughout the system 1600. For example, the functionality is implementable in part on the computing device 1602 as well as via the platform 1616 that abstracts the functionality of the cloud 1614.

In implementations, the platform 1616 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
establishing, by a processing device, a communicative connection with a monitoring module configured to monitor user interaction with an application at a monitored computing device;
receiving, by the processing device, interaction data describing the monitored user interaction as a plurality of events, the plurality of events including, respectively, a capture of a respective user interface of a plurality of user interfaces involved in the monitored user interaction and navigational relationships of the user interfaces to each other;
forming, by the processing device, an element visualization having an element hierarchy based on the navigational relationships and including the captures of the respective user interface; and
presenting, by the processing device, the element visualization for display in an analysis user interface.

2. The method as described in claim 1, wherein the plurality of events describe a location of a user interface element within the respective user interface.

3. The method as described in claim 2, wherein the capture is a screenshot of the respective user interface the location is coordinates defined based on the user interface element with respect to the screenshot.

4. The method as described in claim 1, wherein the establishing includes establishing a communicative connection between the monitoring module and an analysis module executed by the processing device and a communicative connection with an analysis computing device that is configured to display the analysis user interface.

5. The method as described in claim 1, further comprising storing the plurality of events as received from the monitoring module.

6. The method as described in claim 5, wherein the storing includes associating a plurality of storage identifiers (IDs) with the plurality of events and wherein the forming the event visualization includes transmitting the plurality of events based on the plurality of storage identifiers.

7. The method as described in claim 1, wherein the event visualization includes a plurality of nodes represented, respectively, by the plurality of captures having a plurality of edges depicting the element hierarchy as based on the navigational relationships.

8. The method as described in claim 7, wherein the plurality of edges include, respectively, an indication of an amount of navigation performed between said respective user interfaces.

9. The method as described in claim 7, wherein the plurality of nodes are selectable via the user interface to cause output of one or more triggers associated with a respective said node.

10. The method as described in claim 9, wherein the one or more triggers include navigation to the user interface, interaction with an element included in the respective user interface, or completing an action via the respective user interface.

11. The method as described in claim 1, further comprising generating at least one suggestion using machine learning as part of generative artificial intelligence based on the event visualization.

12. The method as described in claim 11, wherein the at least one suggestion is configured to improve an amount of navigation to a respective said user interface, add a user interface, or remove a respective said user interface.

13. The method as described in claim 1, wherein the presenting is performed in real time as the plurality of events are received.

14. A computing device comprising:
a processing device; and
a computer-readable storage medium storing instructions that, responsive to execution by the processing device, causes the processing device to perform operations including:
displaying an element visualization depicting navigation between a plurality of user interfaces of an application, the element visualization formed based on a plurality of events including a plurality of captures of the plurality of user interfaces as disposed within an element hierarchy based on navigational relationships between the plurality of user interfaces;
receiving a subsequent event including a capture of a user interface of the application and a respective navigation relationship with another said user interface; and
updating the element visualization as the subsequent event is received in real time for display in an analysis user interface.

15. The computing device as described in claim 14, further comprising displaying at least one suggestion, the at least one suggestion generated using machine learning as part of generative artificial intelligence based on the event visualization.

16. The computing device as described in claim 15, wherein the at least one suggestion is configured to improve an amount of navigation to a respective said user interface, add a user interface, or remove a respective said user interface.

17. The computing device as described in claim 14, wherein the event visualization includes a plurality of nodes represented, respectively, by the plurality of captures having a plurality of edges depicting the element hierarchy as based on the navigational relationships.

18. The computing device as described in claim 17, wherein the plurality of edges include, respectively, an indication of an amount of navigation performed between said respective user interfaces.

19. One or more computer-readable storage media storing instructions that, responsive to execution by a processing device, causes the processing device to perform operations comprising:
establishing a communicative connection with a monitoring module configured to monitor user interaction with an application at a monitored computing device;
receiving interaction data describing the monitored user interaction as a plurality of events, the plurality of events including, respectively, a capture of a respective user interface of a plurality of user interfaces involved in the monitored user interaction and navigational relationships of the user interfaces to each other;
forming an element visualization having an element hierarchy based on the navigational relationships and including the captures of the respective user interface; and
presenting the element visualization for display in an analysis user interface.

20. The one or more computer-readable storage media as described in claim 19, wherein the operations further comprise displaying at least one suggestion, the at least one suggestion generated using machine learning as part of generative artificial intelligence based on the event visualization.
